(19) United States
(12) Patent Application Publication
(10) Pub. No.: US 2025/0137579 A1
(43) Pub. Date: May 1, 2025

(54) HOLDING MECHANISM

(71) Applicant: DIONEX SOFTRON, Germering (DE)

(72) Inventors: Michael Wohner, Olching (DE); Marcel Borgward, Landsberg (DE)

(21) Appl. No.: 18/494,037

(22) Filed: Oct. 25, 2023

(51) Int. Cl. F16M 13/02; F16B 2/04

(52) U.S. Cl. CPC F16M 13/022; F16B 2/04

(57) ABSTRACT

The present invention relates to a clamp, in particular a clamp for holding a chromatography column, and methods of using such a clamp. A clamp includes a first gripping surface comprising a first recess for accommodating a support; and a second gripping surface comprising a second recess for accommodating the support. The first gripping surface and second gripping surface being connected at one end to a hinge, movable between a first position and a second position; and the hinge defining, in the first position, a first angle between the first gripping surface and the second gripping surface, wherein the recesses provide a clamping force against the support, and defining in the second position, a second angle between the first gripping surface and the second gripping surface, where the clamp is slidable along the support within the recesses.

The present invention relates to a clamp, in particular a clamp for holding a chromatography column, and methods of using such a clamp.

### BACKGROUND OF THE INVENTION

Chromatography techniques, such as liquid chromatography, gas chromatography, low pressure chromatography, medium pressure chromatography, high-performance liquid chromatography (HPLC), ultra-high performance chromatography (UHPLC), etc. can be used, for example, in an analytical role or in a preparative role to separate, identify, and quantify the components of a mixture.

In such chromatography techniques a fluid (“mobile phase”) containing a sample mixture is passed through a column containing a separation medium (“stationary phase.”).

The stationary phase and mobile phase can be chosen such that components in the sample have different affinity for the stationary and mobile phase, causing different flow rates for the different components and leading to the separation of the components as they flow through the column. The stationary phase can be a granular material comprising, for example, a ceramic or a polymeric material, selected for the particular separation being performed.

Usually, one or more so-called separation columns can be used in a column oven. To attach the separation columns in the oven chamber, small holding elements are used, which contain receptacles for one or more columns.

A column holder consisting of two parts is currently used. A plastics part for receiving the column, as well as a flexible metal element for attachment in the oven chamber (see for example U.S. Pat. No. 7,575,676B2).

The part is deliberately designed with sharp edges so that the current attachment using the spring plate generates the desired holding force or frictional force. The spring plate thus digs into the anodised layer of the oven profile with each attachment process. The holding mechanism is therefore non-positive and positive.

This design is problematic because the damage to the anodised layer in conjunction with the moisture that frequently occurs in the oven (in the case of a cooling function) results in strong corrosion (pitting in the aluminium, brown rust spots on the spring plate)

Furthermore, the column clip can no longer be displaced after assembly. It must first be released again and attached elsewhere.

Thus, it would be desirable to provide a clamp that is easy to remove and does not damage the support to which it is attached.

The listing or discussion of an apparently prior-published document in this specification should not necessarily be taken as an acknowledgement that the document is part of the state of the art or is common general knowledge.

### DESCRIPTION OF THE INVENTION

The present inventors have surprisingly and unexpectedly found that at least some of the abovementioned problems can be address by the provision of a clamp (for holding a chromatography column), wherein the clamp comprises:
a first gripping surface comprising a first recess for accommodating a support;
a second gripping surface comprising a second recess for accommodating the support;
the first gripping surface and second gripping surface being connected at one end to a hinge, movable between a first position and a second position;
the hinge defining, in the first position, a first angle between the first gripping surface and the second gripping surface, wherein the recesses provide a clamping force against the support, and defining in the second position, a second angle between the first gripping surface and the second gripping surface, wherein the clamp is support is slidable along the support within the recesses.

The clamp maybe hereinafter referred to as the clamp of the invention.

The clamp of the invention may be used to hold or support any suitable objects. However, it may be preferred that the claim may be for holding at least one chromatography column.

The first gripping surface comprises a first recess for accommodating a support.

The first gripping surface may be formed from any material. For example, the first gripping surface may be plastic or metal. The first gripping surface may preferably be plastic, such as a thermoplastic resin.

The first gripping surface may be any shape but may preferably be substantially cuboid.

The first gripping surface may be positioned such that it is above the second gripping surface and may therefore be described as the upper gripping surface.

The first recess accommodates a support.

As used herein, the term “recess” is intended to mean a hole or gap within the first gripping surface. The recess may be located at any point along the outer edge of the first gripping surface.

The term “accommodates a support” is intended to mean that a support can fit/be received within the recess.

Thus, the recess must be of sufficient size to receive the support and will depend on the intended use.

The recess may have any shape depending on the shape of the support. For example, the recess may have a substantially square or substantially rectangular shape.

The second gripping surface also comprises a recess (second recess) for accommodating a support. The second recess is as defined for the first recess.

As with the first gripping surface, the second gripping surface may be formed of any material. For example, the second gripping surface may be plastic or metal. The second gripping surface may preferably be plastic, such as thermoplastic resin.

The second gripping surface may be any shape but may preferably be substantially cuboid.

The second gripping surface may be positioned such that it is below the first gripping surface and may therefore be described as the lower gripping surface.

The first and second gripping surfaces may be formed from the same material or may be formed from different materials.

The support may be any shape that allows the clamp to be attached to.

The support may be a protrusion (vertical or horizontal). For example, the support may be a vertical protrusion in a chromatography oven.

The support may be any material. For example, the support may be metal or plastic. Preferably, the support may be a metal protrusion, such as a metal (aluminium protrusion in a chromatography oven).

The support may be substantially perpendicular to the gripping surfaces.

The first and second gripping surfaces are connected at one end to a hinge, where the hinge is moveable between a first and second position.

The hinge may be formed from the first and second gripping surfaces or may be an additional component connected to the first and second gripping surfaces.

Where the first and second gripping surfaces form the hinge, the hinge may be formed by the inclusion of a pivot at the connecting end of the first gripping surface or the second gripping surface. Any suitable pivot may be used.

Alternatively, the hinge may be formed by the first and second gripping surfaces being fashioned (formed) from a single piece of material which is bent to provide an angle. Such a hinge shall hereinafter be referred to as a solid state hinge or living hinge.

Where the hinge is formed from a single piece of material this means that the first and second gripping surfaces are initially a single piece of material that is then bent or folded to form/provide a hinge with a first gripping surface on one side of the hinge and a second gripping surface on the opposite side of the hinge. It may therefore be preferred that the hinge is formed centrally in the single piece of material.

The hinge is moveable between a first and second position.

In the first position, the hinge defines a first angle between the first gripping surface and the second gripping surface. In the first angle, the first and second gripping surfaces are positioned such that the first and second recesses provide a clamping force against the support.

In the second position, the hinge defines a second angle between the first gripping surface and the second gripping surface. In the second angle, the first and second gripping surfaces positioned such that the support is slidable within the first and second recesses. In the second position first and second gripping surfaces may be substantially parallel. In the second position, the recesses align such that the support may fit within both the first and second recesses and the clamp can slide along the support. If necessary, in this position, the clamp may also be removed from or added to the support.

Where the hinge is formed by the first and second gripping surfaces being fashioned from a single piece of material which is bent to provide an angle, the angle formed is the first angle. That is the single piece of material is formed with a bend that corresponds to the first angle.

The first angle may be any angle where the first and second recesses do not align, such that it is possible for the support to slide within the recesses.

The second angle may be any angle where the first and second recesses do align or partially align, such that it is possible for the support to slide within the recesses.

The second angle is typically smaller than the first angle.

The hinge may be biased to the first position. That is hinge will automatically move towards the first position.

The hinge may be moved to the second position by compression of the first gripping surface and second gripping surface towards each other. For example, compression of the first and second gripping surfaces to a substantially parallel position and/or where the first and second recesses align or partially align, such that it is possible for the support to slide within the recesses.

The bias may be provided by (the restoring force of) a spring. The spring may be any spring suitable for the size of the clamp and the clamping force required. Suitable springs include, but are not limited to, coil springs and sheet metal springs.

The spring may be located at any point between the first gripping surface and the second gripping surface. However, it would be understood by the skilled person that the spring may preferably be positioned at the point where it would provide a maximum lever, and that this may vary depending on the size of the gripping surfaces and the size of recesses compared to the size of the support.

Alternatively, the bias may be provided by a solid state hinge as previously defined.

Ceasing manipulation/moving, i.e. by stopping compression, allows the hinge to return from the second angle to the first angle. If a support is positioned within the first and second recesses when in the second position as the first and second gripping surfaces return to the first position, the first and second recesses move out of alignment and press against the support providing a clamping force against the support.

The clamp is intended to hold or maintain the position of objects, such as columns, on a support, such as a metal protrusion, such as a metal (aluminium protrusion in a chromatography oven).

The first gripping surface may therefore further comprise at least one protrusion extending from the first gripping surface.

Alternatively, or additionally, the second gripping surface may further comprise at least one protrusion extending from the second gripping surface.

The at least one protrusion may extend in substantially the same plane as the surface.

The protrusion may be any shape. However, it may be preferred that it is a shape adapted to hold an object. For example, a shape adapted to receive a chromatography column and hold the column in a vertical position.

The protrusion may comprise at least one finger. For example, the protrusion may comprise two figures adapted to receive a chromatography column between the two fingers.

The present invention also provides a method of attaching a clamp to a support comprising:
(a) Providing a clamp as defined above;
(b) Moving the hinge from the first position to the second position,
(c) Positioning the clamp such that the support is positioned inside the first and second recesses; and
(d) Returning the hinge to the first position.

For the avoidance of doubt, in this specification when we use the term “comprising” or “comprises” we mean that the feature being described must contain the listed component(s) but may optionally contain additional components. When we use the term “consisting essentially of” or “consists essentially of” we mean that the feature being described must contain the listed component(s) and may also contain other components provided that any components do not affect the essential properties of the feature. When we use the term “consisting of” or “consists of” we mean that the feature being described must contain the listed component(s) only.

It would be clear to the person skilled in the art that the features and combinations defined with respect to the charged particle microscope, apply equally to the method and combination defined above.

The drawings, which are not necessarily to scale, depict selected embodiments and are not intended to limit the scope of the invention. The detailed description illustrates, by way of example, not by way of limitation, the principles of the invention. The description will clearly enable one skilled in the art to make and use the invention, and described several embodiments, adaptions, variations, alternatives and uses of the invention. As used herein, the terms “about” or “approximately” for any numerical values or ranges indicate a suitable dimensional tolerance that allows the part or collection of components to functions for its intended purpose as described.

The invention will be described in more detail below on the basis of the figures.

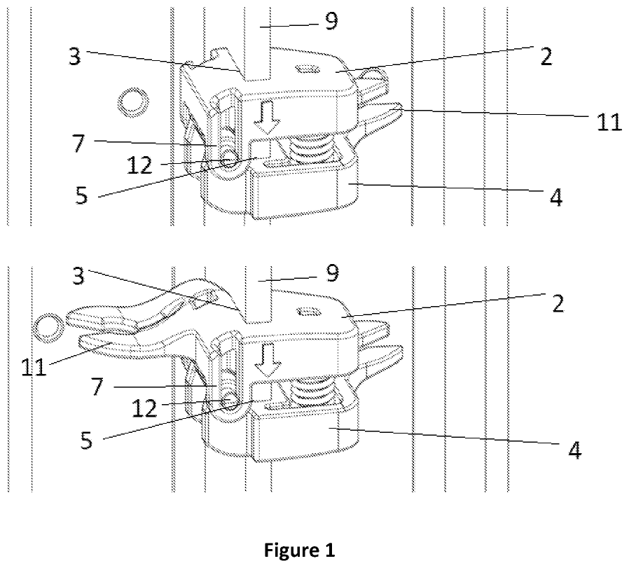

FIG. 1 shows two possible embodiments of the clamp of the invention.

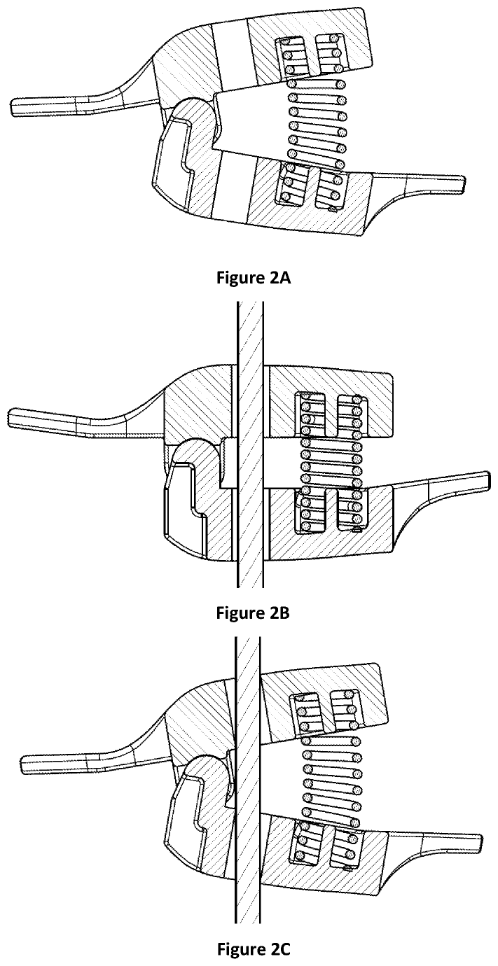

FIGS. 2A, 2B, and 2C shows the clamp in a first position (FIG. 2A), in a second position (FIG. 2B) and in the first position providing the clamping force (FIG. 2C).

### DETAILED DESCRIPTION OF THE INVENTION

The clamps as shown in FIG. 1, comprise a first gripping surface (2) and a second gripping surface (4). As shown, the first gripping surface forms the upper surface and is positioned directly above the second gripping surface, which forms the lower surface. The first gripping surface comprises a first recess (3) and the second gripping surface comprises a second recess (5).

In FIG. 1, the clamps are both shown in the first position, where a hinge (7) defines a first angle between the first gripping surface (2) and the second gripping surface (4).

A support (9) passes through the first and second recesses with a spring (10) providing the hinge with a bias to the first position such that the first and second recesses press against the support providing a clamping force that retains the position of the clamp on the support.

Protrusions (11) extend from the first and/or second gripping surface. Although the protrusion may take any form, in FIG. 1, the protrusions (11) are shown to comprise two fingers, such that a chromatography column may be supported in a vertical position between the two fingers.

As explained above, any hinge configuration may be used. In FIG. 1, the hinge is formed between the ends of the first and second gripping surface. As shown, the second gripping surface provides a pivot point (12) and the first gripping surface extends around the pivot point to form the hinge.

Movement between the first and second positions in order to provide a clamping force is shown in FIGS. 2A, 2B and 2C.

As shown, the first and second gripping surfaces are moved together from the first position (2A) into the second position (2B) by compression of the spring (or solid state hinge bias). In the second position, the hinge defines a second angle. In the second angle, the first and second recesses in the first and second gripping surfaces align such that the clamp can be place onto and/or slide along and/or be removed from a support (9).

Removing the compression force allows for the first and second gripping surfaces to return to the first position (2C) providing a clamping force against a support.

1. A clamp, wherein the clamp comprises:
a first gripping surface comprising a first recess for accommodating a support;
a second gripping surface comprising a second recess for accommodating the support;
the first gripping surface and second gripping surface being connected at one end to a hinge, movable between a first position and a second position;
the hinge defining, in the first position, a first angle between the first gripping surface and the second gripping surface, wherein the recesses provide a clamping force against the support, and defining in the second position, a second angle between the first gripping surface and the second gripping surface, where the clamp is slidable along the support within the recesses.

2. A clamp according to claim 1, wherein the second angle is smaller than the first angle.

3. A clamp according to claim 1, wherein the hinge is biased to the first position.

4. A clamp according to claim 1, wherein the bias is provided by a spring.

5. A clamp according to claim 1, wherein the bias is provided by a solid state hinge.

6. A clamp according to claim 1, wherein the hinge is moved to the second position by compression of the first gripping surface and second gripping surface towards each other.

7. A clamp according to claim 1, wherein the first gripping surface further comprises at least one protrusion extending from the first gripping surface.

8. A clamp according to claim 1, wherein the second gripping surface further comprises at least one protrusion extending from the second gripping surface.

9. A clamp according to claim 7, wherein the at least one protrusion extends in substantially the same plane as the surface.

10. A clamp to claim 7, wherein the at least one protrusion is adapted to receive a chromatography column.

11. A clamp according to claim 1, wherein the support is substantially perpendicular to the gripping surfaces.

12. A method of attaching a clamp to a support comprising:
(e) Providing a clamp as defined in claim 1;
(f) Moving the hinge from the first position to the second position,
(g) Positioning the clamp such that the support is positioned inside the recesses; and
(h) Returning the hinge to the first position.
